(19) United States
(12) Patent Application Publication
(10) Pub. No.: US 2025/0242833 A1
(43) Pub. Date: Jul. 31, 2025

(54) APPARATUSES, SYSTEMS, AND METHODS FOR PLANNING INTERSECTION TURNS

(71) Applicant: Toyota Jidosha Kabushiki Kaisha, Aichi-ken (JP)

(72) Inventors: Zachary A. Schellhardt, Seattle, WA (US); Jan Falkowski, Seattle, WA (US)

(73) Assignee: Toyota Jidosha Kabushiki Kaisha, Aichi-ken (JP)

(21) Appl. No.: 18/427,130

(22) Filed: Jan. 30, 2024

(51) Int. Cl. B60W 60/00; B60W 30/18; G06N 3/08

(52) U.S. Cl. CPC B60W 60/0011; B60W 30/18154; B60W 30/18159; G06N 3/08; B60W 2556/10; B60W 2556/40

(57) ABSTRACT

Disclosed apparatuses, systems, and methods are directed for trajectory planning. Example apparatuses comprise one or more processors operable to receive an instruction to turn within an intersection, plan a trajectory for an autonomous vehicle to turn within the intersection based on map data comprising one or more optimal turning paths associated with the intersection, and instruct the autonomous vehicle to follow the trajectory to pass the intersection. The one or more optimal turning paths are generated based on turning paths of one or more human-driven vehicles.

### TECHNICAL FIELD

The present disclosure relates to apparatuses, systems, and methods for vehicle control, more specifically, to apparatuses, systems, and methods for vehicle control by planning intersection turning.

### BACKGROUND

Intersections pose challenges for vehicles as they contend for space within the same area. Intersections involve multiple lanes, opposing traffic, and traffic signs that require determining the right of way. Relying on real-time decision-making at intersections can lead to uncertainty. Therefore, there is a need to establish planned intersection turns for vehicles, aiming to reduce potential traffic risks and enhance the efficiency of navigating intersections.

### SUMMARY

In one embodiment, an apparatus for trajectory planning comprising one or more processors operable to receive an instruction to turn within an intersection, plan a trajectory for an autonomous vehicle to turn within the intersection based on map data comprising one or more optimal turning paths associated with the intersection, wherein the one or more optimal turning paths are generated based on turning paths of one or more human-driven vehicles, and instruct the autonomous vehicle to follow the trajectory to pass the intersection.

In another embodiment, a method for trajectory planning includes receiving an instruction to turn within an intersection, planning a trajectory for an autonomous vehicle to turn within the intersection based on map data comprising on one or more optimal turning paths associated with the intersection, wherein the one or more optimal turning paths are generated based on turning paths of one or more human-driven vehicles, and instructing the autonomous vehicle to follow the trajectory to pass the intersection.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts an example system for trajectory planning of intersection turns of the present disclosure, in accordance with one or more embodiments shown and described herewith;

FIG. 2 schematically depicts example components of the apparatus and system for trajectory planning of intersection turns of the present disclosure, according to one or more embodiments shown and described herein;

FIG. 3 depicts an illustrative block diagram of generating the planned trajectory at an intersection of the present disclosure, according to one or more embodiments shown and described herein; and

FIG. 4 depicts a flowchart of illustrative steps for generating the planned intersection turns at the intersection of the present disclosure, according to one or more embodiments shown and described herein.

### DETAILED DESCRIPTION

The disclosed embodiments include apparatuses, systems, and methods for trajectory planning at intersections based on map data including one or more optimal turning paths. The optimal turning paths may be generated based on the turning paths of one or more human-driven vehicles. The disclosed embodiments include apparatuses, systems, and methods that are useful for autonomous vehicles in planning trajectories to pass intersections. Autonomous vehicles relying on real-time decision-making at intersections may have difficulty navigating through an intersection, leading to undesirable wide turns that have the autonomous vehicles go out into the intersection. Such wide turns may cause traffic flow disruption, increase the risk of collision with other vehicles, pedestrians, or cyclists within the intersections.

By encoding the optimal turning path of human-driven vehicles into sections within map data, the autonomous vehicles can make turns within the intersection more naturally and desirably. The disclosed embodiments further include apparatuses, systems, and methods having artificial intelligence functions to continuously improve the optimal turning paths based on the generated planned trajectory. Accordingly, the disclosed apparatuses, systems, and methods are useful in mitigating issues related to navigating vehicles passing an intersection, such as wide turns that may extend into the intersection, thereby improving overall traffic flow and vehicle interactions. Further, the artificial intelligence functions enhance the system capabilities by continuously refining optimal turning paths based on generated planned trajectories to ensure that the trajectory planning system evolves, accommodating changes in traffic dynamics and contributing to the efficient and desirable safe navigation of intersections by autonomous vehicles and ensuring that the trajectory planning remains robust and responsive to evolving road conditions, traffic patterns, and other dynamic factors. The trajectory planning system not only prioritizes safety and natural maneuvering but also demonstrates efficiency in its use of map data. The integration of optimal turning paths into the map data facilitates precise decision-making for autonomous vehicles, leveraging spatial information to navigate intersections effectively.

Various embodiments of the methods and systems for trajectory planning are described in more detail herein. Whenever possible, the same reference numerals will be used throughout the drawings to refer to the same or like parts. As used herein, the singular forms “a,” “an” and “the” include plural referents unless the context clearly dictates otherwise. Thus, for example, reference to “a” component includes aspects having two or more such components unless the context clearly indicates otherwise.

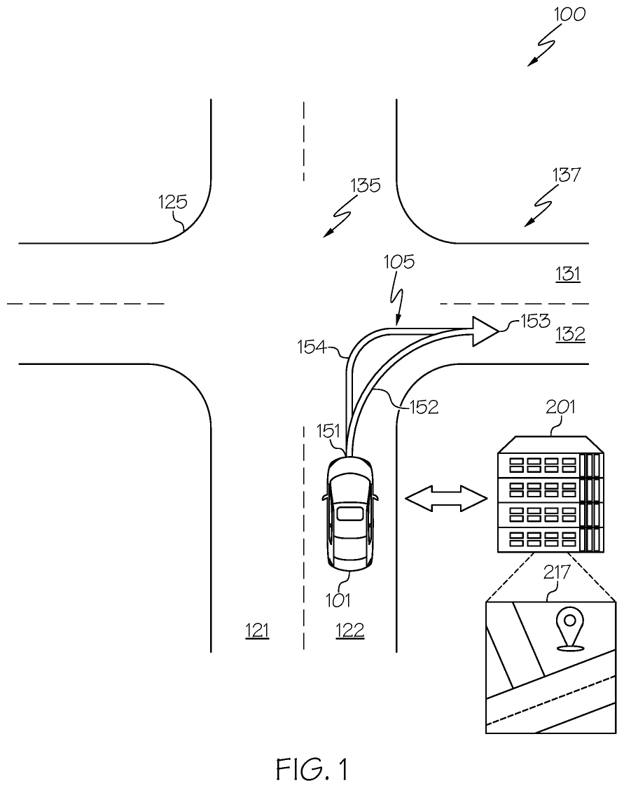

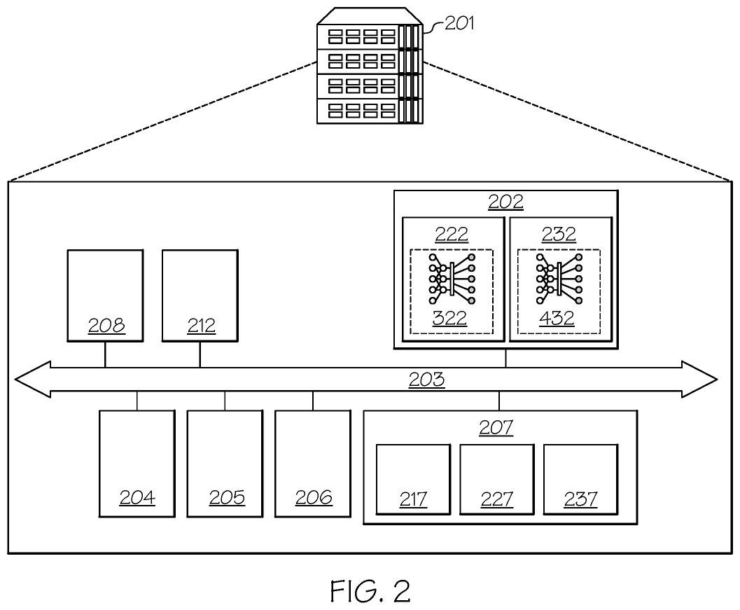

Referring to the figures, FIGS. 1 and 2 schematically depict an example trajectory planning system 100. The trajectory planning system 100 may include one or more controllers 201, which may further include one or more modules, such as a trajectory generation module 222 and an optimal turning path module 232.

The trajectory generation module 222 may include one or more first machine-learning algorithms, such as first neural networks 322. The trajectory generation module 222 may generate a planned trajectory 105. The planned trajectory 105 may include an upcoming turning path, and velocity, time, and kinematics of the vehicle 101 associated with the upcoming turning path.

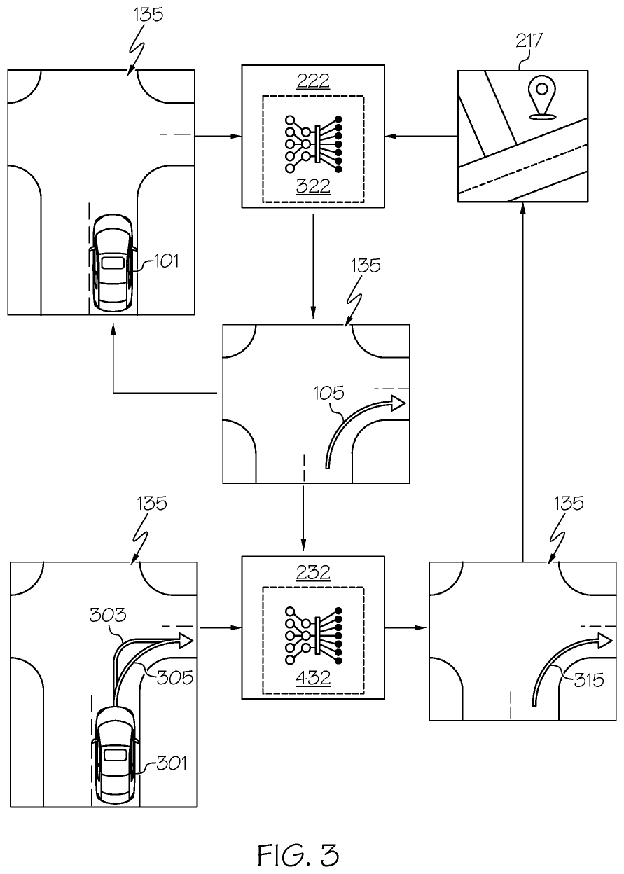

The optimal turning path module 232 may include one or more second machine-learning algorithms, such as second neural networks 432. The second machine-learning algorithm may generate one or more optimal turning paths 315 (as illustrated in FIG. 3) associated with an intersection 135. The information on the optimal turning paths 315 and the intersection 135 may be stored in map data 217. The map data 217 may include pedestrian crossings, traffic lights, traffic signs, barriers, road lanes, road edges, shoulders, dividers, paint markings, poles, or a combination thereof. In embodiments, the map data 217 may be high-definition (HD) map data or standard-definition (SD) map data. A SD map containing SD map data is based on curves, elevation, and coordinates of roads. A SD map may be at a resolution of meter. A HD map containing HD map data may include more details than a SD map containing the SD map data. The HD map may be at resolution from sub-meter to centimeter. The HD map data may include all the information included in the SD map data and more, such as road shape, road marking, traffic signs, barriers, poles, guardrails, walls, and barriers.

The trajectory planning system 100 may include one or more vehicles 101, which may be autonomous vehicles. In some embodiments, the one or more controllers 201 are included in the vehicles 101. In some embodiments, some of the vehicles 101 may include communication devices, such as vehicle network interface hardware, operable to wirelessly communicate with the controllers 201. In some embodiments, the controller 201 may be included in one or more servers including server communication devices, such as network interface hardware 206, operable to communicate with the vehicles 101.

Each of the vehicles 101 may be an automobile or any other passenger or non-passenger vehicle such as, for example, a terrestrial, aquatic, and/or airborne vehicle. Each of the vehicles 101 may be an autonomous vehicle that navigates its environment with limited human input or without human input. Each of the vehicles 101 may drive on a road and perform vision-based lane centering, e.g., using one or more sensors. Each of the vehicles 101 may include actuators for driving the vehicle, such as a motor, an engine, or any other powertrain. The vehicles 101 may move on various surfaces, such as, without limitations, roads, highways, streets, expressways, bridges, tunnels, parking lots, garages, off-road trails, railroads, or any surfaces where the vehicles may operate.

In embodiments, the vehicles 101 may move on a road 137, which includes one or more intersections 135. The intersections 135 may include one or more lanes. The intersections 135 may include traffic signs, signals, roundabouts, and other structures to control the traffic flow. The intersections 135 may be four-way, crossroads, three ways (such as T-junction and Y junction), or five or more ways. For example, as illustrated in FIG. 1, the road 137 may include a vertical road and a horizontal road. The vertical road may include two-way lanes, namely a lane 121 in a south direction, and a lane 122 in a north direction. The horizontal road may include two-way lanes, a lane 131 in a west direction, and a lane 132 in an east direction. The vertical road and the horizontal road may cross at the intersection 135. The intersection 135 may include one or more curbs 125 at the joints of the vertical road and the horizontal road.

Referring to FIG. 2, example components of controller 201 are schematically depicted. Although FIG. 2 illustrates one controller 201, in some embodiments, the trajectory planning system 100 may include two or more controllers 201. The controller 201 or the vehicles 101 may include one or more vision sensors 208 and vehicle sensors 212. The vision sensors 208 may be used for capturing images or videos of the environment around the vehicles 101. In some embodiments, the one or more vision sensors 208 include one or more imaging sensors configured to operate in the visual and/or infrared spectrum to sense visual and/or infrared light. Additionally, while the particular embodiments described herein are described with respect to hardware for sensing light in the visual and/or infrared spectrum, it is to be understood that other types of sensors are contemplated. For example, the systems described herein could include one or more LIDAR sensors, radar sensors, sonar sensors, or other types of sensors for gathering data that could be integrated into or supplement the data collection described herein. Ranging sensors like radar may be used to obtain rough depth and speed information for the view of the vehicle 101. The one or more vision sensors 208 may include a forward-facing camera installed in the vehicles 101. The one or more vision sensors 208 may be any device having an array of sensing devices capable of detecting radiation in an ultraviolet wavelength band, a visible light wavelength band, or an infrared wavelength band. The one or more vision sensors 208 may have any resolution. In some embodiments, one or more optical components, such as a mirror, fish-eye lens, or any other type of lens may be optically coupled to the one or more vision sensors 208. In embodiments described herein, the one or more vision sensors 208 may provide image data to the one or more processors 204 or another component communicatively coupled to the communication path 203. In some embodiments, the one or more vision sensors 208 may also provide navigation support. That is, data captured by the one or more vision sensors 208 may be used to autonomously or semi-autonomously navigate a vehicle.

The controller 201 or the vehicles 101 may include one or more vehicle sensors 212. Each of the one or more vehicle sensors 212 is coupled to the communication path 203 and communicatively coupled to the one or more processors 204. The one or more vehicle sensors 212 may include one or more speed sensors or motion sensors for detecting and measuring motion and changes in motion of a vehicle, e.g., the vehicle 101. The motion sensors may include inertial measurement units. Each of the one or more motion sensors may include one or more accelerometers and one or more gyroscopes. Each of the one or more motion sensors transforms the sensed physical movement of the vehicle into a signal indicative of an orientation, a rotation, a velocity, or an acceleration of the vehicle. The acquired data from the vehicle sensors 212 may be used to determine the vehicle kinematics of the vehicles 101.

The vision sensors 208 and the vehicle sensors 212 may be used to collect vehicle control data, road condition data, and vehicle kinematic data. The vehicle control data, the road condition data, and the vehicle kinematic data may be used to monitor an actual trajectory of the vehicle 101 in passing the intersection 135. The vehicle control data may include throttle position, brake status, steering angle, and gear selection of the vehicle 101. The road condition data may include road type, friction coefficient, and surface irregularities (e.g., bumps). The vehicle kinematic data may include velocity, acceleration, position, and orientation of the vehicle 101.

The controller 201 may include one or more processors 204. Each of the one or more processors 204 may be any device capable of executing machine-readable and executable instructions. The instructions may be in the form of a machine-readable instruction set stored in data storage component 207 and/or a memory component 202. Accordingly, each of the one or more processors 204 may be a controller, an integrated circuit, a microchip, a computer, or any other computing device. The one or more processors 204 are coupled to a communication path 203 that provides signal interconnectivity between various modules of the system. Accordingly, the communication path 203 may communicatively couple any number of processors 204 with one another, and allow the modules coupled to the communication path 203 to operate in a distributed computing environment. Specifically, each of the modules may operate as a node that may send and/or receive data. As used herein, the term “communicatively coupled” means that coupled components are capable of exchanging data signals with one another such as for example, electrical signals via a conductive medium, electromagnetic signals via air, optical signals via optical waveguides, and the like.

Accordingly, the communication path 203 may be formed from any medium that is capable of transmitting a signal such as for example, conductive wires, conductive traces, optical waveguides, or the like. In some embodiments, the communication path 203 may facilitate the transmission of wireless signals, such as WiFi, Bluetooth®, Near Field Communication (NFC), and the like. Moreover, the communication path 203 may be formed from a combination of mediums capable of transmitting signals. In one embodiment, the communication path 203 comprises a combination of conductive traces, conductive wires, connectors, and buses that cooperate to permit the transmission of electrical data signals to components such as processors, memories, sensors, input devices, output devices, and communication devices. Accordingly, the communication path 203 may comprise a vehicle bus, such as for example a LIN bus, a CAN bus, a VAN bus, and the like. Additionally, it is noted that the term “signal” means a waveform (e.g., electrical, optical, magnetic, mechanical, or electromagnetic), such as DC, AC, sinusoidal wave, triangular wave, square wave, vibration, and the like, capable of traveling through a medium.

The controller 201 may include one or more memory components 202 coupled to the communication path 203. The one or more memory components 202 may comprise RAM, ROM, flash memories, hard drives, or any device capable of storing machine-readable and executable instructions such that the machine-readable and executable instructions can be accessed by the one or more processors 204. The machine-readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine-readable and executable instructions and stored on the one or more memory components 202. Alternatively, the machine-readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

The one or more memory components 202 may include one or more modules, including the trajectory generation module 222 and the optimal turning path module 232. Each of the one or more modules may include, but is not limited to, routines, subroutines, programs, objects, components, data structures, and the like for performing specific tasks or executing specific data types as will be described below. The data storage component 207 may store map data including the intersections 135, the road 137, the optimal turning paths 315. The data storage component 207 may further store training data 227 for training the trajectory generation module 222 and the optimal turning path module 232. The training data 227 may include the ground truth data related to the trajectory planning at one or more intersections for human-driven vehicles and autonomous vehicles. The data storage component 207 may store historical data 237, such as historical vehicle kinematic data, historical vehicle control data, historical road condition data, historical trajectory data of the vehicle 101, and other historical data related to operation of the vehicle 101, and historical sensor data of the human-driven vehicles 301 (e.g. as illustrated in FIG. 3). The trajectory generation module 222 and the optimal turning path module 232 may also be stored in the data storage component 207 during operating or after the operation.

The one or more modules, including the trajectory generation module 222 and the optimal turning path module 232, may include one or more machine-learning algorithms, such as neural networks. The modules may be trained and provided with machine learning capabilities via a neural network as described herein. By way of example, and not as a limitation, the neural network may utilize one or more artificial neural networks (ANNs). In ANNs, connections between nodes may form a directed acyclic graph (DAG). ANNs may include node inputs, one or more hidden activation layers, and node outputs, and may be utilized with activation functions in the one or more hidden activation layers such as a linear function, a step function, logistic (Sigmoid) function, a tanh function, a rectified linear unit (ReLu) function, or combinations thereof. ANNs are trained by applying such activation functions to training data sets to determine an optimized solution from adjustable weights and biases applied to nodes within the hidden activation layers to generate one or more outputs as the optimized solution with a minimized error. In machine learning applications, new inputs may be provided (such as the generated one or more outputs) to the ANN model as training data to continue to improve accuracy and minimize error of the ANN model. The one or more ANN models may utilize one-to-one, one-to-many, many-to-one, and/or many-to-many (e.g., sequence-to-sequence) sequence modeling. The one or more ANN models may employ a combination of artificial intelligence techniques, such as, but not limited to, Deep Learning, Random Forest Classifiers, Feature extraction from audio, images, clustering algorithms, or combinations thereof. In some embodiments, a convolutional neural network (CNN) may be utilized. For example, a convolutional neural network (CNN) may be used as an ANN that, in the field of machine learning, for example, is a class of deep, feed-forward ANNs applied for audio analysis of the recordings. CNNs may be shift or space-invariant and utilize shared-weight architecture and translation. Further, each of the various modules may include one or more generative artificial intelligence algorithms. The generative artificial intelligence algorithm may include a general adversarial network (GAN) that has two networks, a generator model and a discriminator model. The generative artificial intelligence algorithm may also be based on variation autoencoder (VAE) or transformer-based models.

The controller 201 may include input/output hardware 205 coupled to the communication path 203. The input/output hardware 205 may include a monitor, keyboard, mouse, printer, camera, microphone, speaker, and/or other device for receiving, sending, and/or presenting data. The controller 201 may include network interface hardware 206 for communicatively coupling the controller 201 to external resources (e.g., the vehicles 101 or smart devices), Internet of Things (IoTs), and/or a server. The network interface hardware 206 can be communicatively coupled to the communication path 203 and can be any device capable of transmitting and/or receiving data via a network. Accordingly, the network interface hardware 206 can include a communication transceiver for sending and/or receiving any wired or wireless communication. For example, the network interface hardware 206 may include an antenna, a modem, LAN port, WiFi card, WiMAX card, mobile communications hardware, near-field communication hardware, satellite communication hardware, and/or any wired or wireless hardware for communicating with other networks and/or devices. In one embodiment, the network interface hardware 206 includes hardware configured to operate in accordance with the Bluetooth® wireless communication protocol. For example, the network interface hardware 206 of the trajectory planning system 100 may receive and/or transmit map data 217, planned trajectory 105, sensory data of the vehicle 101 (such as, speed data, acceleration data, steering data, yaw data, wheel slip data, lane departure data, time-of-day, weather conditions, vehicle type, vehicle size, minimum and maximum vehicle turning radii) with a server or the vehicles 101.

Referring to FIGS. 1 and 3, examples of the trajectory planning system 100 using the trajectory generation module 222 to generate the planned trajectory 105 for the vehicle 101 (such as an autonomous vehicle) approaching the upcoming intersection 135 to pass the intersection 135 based on one or more optimal turning paths 315 included in the map data 217 are depicted. FIGS. 1 and 3 further depicts an example of the trajectory planning system 100 using the optimal turning path module 232 to generate one or more optimal turning paths 315 associated with the intersection 135 in the map data 217.

In embodiments, the vehicle 101 may detect the upcoming intersection 135 on the road 137 and send an instruction to the controller 201 to assist in turning within the intersection 135. After receiving the instruction to turn, the controller 201 may generate the planned trajectory 105 based on the one or more optimal turning paths 315 stored in the map data 217 for the vehicle 101, such as autonomous vehicles, and instruct the vehicle 101 to follow the trajectory to pass the intersection 135. The planned trajectory 105 may include the upcoming turning path, and velocity, time, and kinematics of the vehicle 101 associated with the upcoming turning path. Each upcoming turning path may be an entering point 151 at a boundary of the intersection 135, an existing point 153 at the boundary of the intersection 135, and a geometric path 152 between the entering point 151 and the existing point 153. In some embodiments, the upcoming turning path may be one of the one or more optimal turning paths 315.

In some embodiments, the vehicles 101 may use the vision sensors 208 and the vehicle sensors 212 to generate and transmit sensory data, such as the vehicle kinematic data, the vehicle control data, and the road condition data to the controller 201. In embodiments, the vehicle kinematic data may be a vehicle position, a vehicle velocity, and a vehicle acceleration of the vehicle 101. The vehicle control data may be vehicle steering, vehicle throttle, and brake inputs of the vehicle 101. The road condition data may include road surface conditions, road geometry, and traffic conditions of the road 137. Upon receiving the sensory data and other input data, such as local weather conditions, the controller 201 may generate, using the trajectory generation module 222, the planned trajectory 105 of the vehicle 101

In some embodiments, the planned trajectory 105 may be generated further based on parameters of the vehicle 101 against parameters of the human-driven vehicles 301 associated with the one or more optimal turning paths 315. The parameters of the vehicle 101 and the parameters of the human-driven vehicles 301 may include vehicle length, minimum turning radii, steering system, acceleration and deceleration performance, or other parameters related to turning performance in the intersection 135. The trajectory planning system 100 may compare the similarity of the parameters between the vehicle 101 and the human-driven vehicle 301 and further adjust the planned trajectory 105 inversely proportional to the similarity. In some embodiments, the trajectory planning system 100 may determine whether the similarity is equal to or more than a threshold similarity. The trajectory planning system 100 may select the optimal turning paths 315 associated with the similarity equal to or more than the threshold similarity in generating the planned trajectory 105 and disregard the optimal turning paths 315 associated with the similarity less than the threshold similarity.

In some embodiments, the trajectory planning system 100 may collect the sensory data from vision sensors 208 and vehicle sensors 212 and further operate the vehicle 101 to follow the planned trajectory 105 by controlling or adjusting steering, throttle, braking inputs of the vehicle 101. The trajectory planning system 100 may monitor a track 154 of the vehicle 101 while the vehicle 101 passing the intersection, and determine whether the track 154 strays from the planned trajectory 105. In responses to determining that the track 154 strays from the planned trajectory 105 (for example, as illustrated in FIG. 1, the track 154 is different than the geometric path 152), the trajectory planning system 100 may generate an updated trajectory for the vehicle 101 to pass the intersection 135 based on historical turning paths 303 and 305 of the human-driven vehicles 301.

As illustrated in FIG. 3, the trajectory planning system 100 may use the optimal turning path module 232 to generate the one or more optimal turning paths 315 associated with the intersection 135 based on turning paths 303 and 305 of one or more human-driven vehicles 301. In some embodiments, the optimal turning paths 315 may be an average turning path of the input turning paths 303 and 305 of the human-driven vehicles 301. In some embodiments, the optimal turning paths 315 may be a shortest turning path of the input turning paths 303 and 305 of the human-driven vehicles 301. In some embodiments, the optimal turning paths 315 may be a most energy-efficient turning path of the input turning paths 303 and 305 of the human-driven vehicles 301. The one or more optimal turning paths 315 may be generated further based on historical sensor data of the human-driven vehicles 301 over time. The sensor data may include speed data, acceleration data, steering data, yaw data, wheel slip data, lane departure data, time of day, weather conditions, vehicle type, vehicle size, minimum and maximum vehicle turning radii, or a combination thereof.

Referring to FIGS. 2 and 3, in embodiments, the trajectory generation module 222 and the optimal turning path module 232 may include one or more neural networks 322 and 432. Each of the neural networks 322 and 432 may include an encoder, one or more layers of hidden layers, and a decoder. The neural networks 322 and 432 may feed training data 227 during the pre-training process into the encoder to generate a lower-dimensional representation of the target input-output pairs. For example, the lower-dimensional representation may include the input of sensory data collected using the vision sensor 208 and vehicle sensors 212 pairing with planned trajectories as well as detected trajectories of the vehicles 101. The first neural network 322 may output planned trajectory 105. The second neural network 432 may output optimal turning path 315 to be integrated into the map data 217.

In some embodiments, the trajectory generation module 222 and the optimal turning path module 232 may include one or more neural networks 322 and 432 having been trained with the training data 227 and the historical data 237. The neural networks 322 and 432 may include the encoder or/and the decoder conjunct with a layer normalization operation or/and an activation function operation. The encoded input data may be normalized and weighted through the activation function before being fed to the hidden layers. The hidden layers may generate a representation of the input data at a bottleneck layer. After delivering neural-network processed data to the final layer of the neural network, a global layer normalization may be conducted to normalize the planned trajectories and optimal turning paths. The outputs may be normalized and converted using an activation function for training and verification purposes, as described in detail further below. The activation function may be linear or nonlinear. The activation function may be, without limitations, a Sigmoid function, a Softmax function, a hyperbolic tangent function (Tanh), or a rectified linear unit (ReLU). The neural networks 322 and 432 may feed the encoder with historical data 237, such as historical vehicle kinematic data, historical vehicle control data, historical road condition data, historical planned trajectory, historical detected trajectory, historical turning paths of human-driven vehicles, and other historical vehicle operation data for continuation training.

In embodiments, the one or more vehicle modules may be pre-trained using training data 227, including ground-truth examples and scenarios where multiple entities (e.g. the vehicles 101 and the human-driven vehicles 301) driving on the road 137 including multiple lanes 121, 122, 131, and 132, intersections 135, and curbs 125. The pre-training may include labeling the entities and desirable planned trajectories and optimal turning paths based on the entities and the intersections 135 in the examples and scenarios and using one or more neural networks 322 and 432 to learn to predict the desirable and undesirable trajectory and optimal turning paths based on the training data 227. The pre-training may further include fine-tuning, evaluation, and testing steps. The modules may be continuously trained using the real-world collected data as the historical data 237 to adapt to changing conditions and factors and improve the performance over time. The neural network may be trained based on the activation functions mentioned further above. The encoder may generate encoded input data h=(Wx+b) that is transformed from the input data of one or more input channels. The encoded input data of one of the input channels may be represented as hᵢⱼ=g(Wxᵢⱼ+b) from the raw input data xᵢⱼ, which is then used to reconstruct output \tilde{x}ᵢⱼ=f(W^{T}hᵢⱼ+b′). The neural networks may reconstruct outputs, such as planned trajectories 105 and optimal turning path 315, into x′=(W^{T}h+b′), where W is weight, b is bias, W^{T} and b′ are transverse values of W and b and are learned through backpropagation. In this operation, the neural networks may calculate, for each input data, a distance between an input data x and a reconstructed input data x′, to yield a distance vector |x-x′|. The neural networks 322 and 432 may minimize the loss function which is a utility function as the sum of all distance vectors. The training process may enable the neural networks 322 and 432 to learn linear or non-linear representations of the input data. The accuracy of the predicted output may be evaluated by satisfying a preset value, such as a preset accuracy and area under the curve (AUC) value computed using an output score from the activation function (e.g. the Softmax function or the Sigmoid function). For example, the trajectory planning system 100 may assign the preset value of the AUC with the value of 0.7 to 0.8 as an acceptable simulation, 0.8 to 0.9 as an excellent simulation, or more than 0.9 as an outstanding simulation. After the training satisfies the preset value, the updated neural networks 322 and 432 may be stored in the trajectory generation module 222 and the optimal turning path module 232, respectively, which are used to generate future planned trajectories and optimal turning paths.

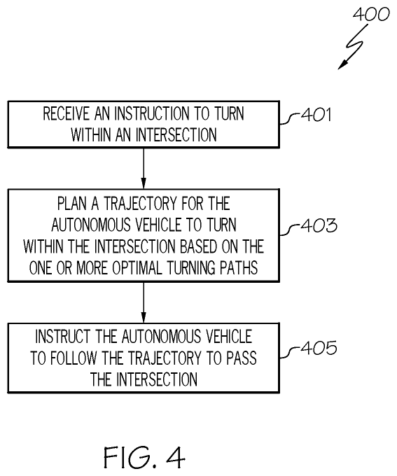

Referring to FIG. 4, a flowchart of a method 400 for trajectory planning is depicted. At block 401, the present method 400 includes receiving an instruction to turn within the intersection 135. At block 403, the present method 400 includes planning a trajectory 105 for the vehicle 101 to turn within the intersection 135 based on one or more optimal turning paths 315 associated with the intersection 135 in the map data 217. The one or more optimal turning paths 315 are generated based on turning paths 303 and 305 of one or more human-driven vehicles 301.

In some embodiments, the map data 217 may include pedestrian crossings, traffic lights, traffic signs, barriers, road lanes, road edges, shoulders, dividers, paint markings, poles, or a combination thereof. The map data 217 may be HD map data or SD map data.

In some embodiments, the one or more optimal turning paths 315 may be generated further based on historical sensor data of the human-driven vehicles 301 over time. The sensor data may include speed data, acceleration data, steering data, yaw data, wheel slip data, lane departure data, time-of-day, weather conditions, vehicle type, vehicle size, minimum and maximum vehicle turning radii, or a combination thereof. The planned trajectory 105 may include an upcoming turning path, and velocity, time, and kinematics of the vehicle 101 associated with the upcoming turning path.

In some embodiments, the planned trajectory 105 may be generated, using a trained first machine-learning algorithm (such as the first neural network 322 in FIGS. 2 and 3), based on the one or more optimal turning paths 315, and parameters of the vehicle 101 against parameters of the human-driven vehicles 301 associated with the one or more optimal turning paths 315. The parameters of the vehicle 101 and the parameters of the human-driven vehicles 301 may include vehicle length, minimum turning radii, steering system, acceleration and deceleration performance, or a combination thereof.

In some embodiments, the one or more optimal turning paths 315 may be generated by a second trained machine-learning algorithm (such as the second neural network 432 in FIGS. 2 and 3) configured to reduce path lengths of the optimal turning paths.

At block 405, the present method 400 includes instructing the vehicle 101 to follow the planned trajectory 105 to pass the intersection 135. The present method 400 may further include operating the vehicle 101 to follow the planned trajectory 105 by controlling or adjusting steering, throttle, braking inputs of the vehicle 101, or a combination thereof. The present method 400 may further include monitoring a track 154 of the vehicle 101 while passing the intersection 135, determining whether the track 154 strays from the planned trajectory 105, and in response to determining that the track 154 strays from the planned trajectory 105, generating an updated trajectory for the vehicle 101 to pass the intersection 135 based on historical turning paths 303 and 305 of the human-driven vehicles 301.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An apparatus for trajectory planning comprising one or more processors operable to:
receive an instruction to turn within an intersection;
plan a trajectory for an autonomous vehicle to turn within the intersection based on map data comprising on one or more optimal turning paths associated with the intersection, wherein the one or more optimal turning paths are generated based on turning paths of one or more human-driven vehicles; and
instruct the autonomous vehicle to follow the trajectory to pass the intersection.

2. The apparatus of claim 1, wherein the one or more optimal turning paths are generated further based on historical sensor data of the human-driven vehicles over time.

3. The apparatus of claim 2, wherein the trajectory is generated, using a trained first machine-learning algorithm, based on the one or more optimal turning paths, and parameters of the autonomous vehicle against parameters of the human-driven vehicles associated with the one or more optimal turning paths.

4. The apparatus of claim 3, wherein the parameters of the autonomous vehicle and the parameters of the human-driven vehicles comprise vehicle length, minimum turning radii, steering system, acceleration and deceleration performance, or a combination thereof.

5. The apparatus of claim 2, wherein the sensor data comprises speed data, acceleration data, steering data, yaw data, wheel slip data, lane departure data, time-of-day, weather conditions, vehicle type, vehicle size, minimum and maximum vehicle turning radii, or a combination thereof.

6. The apparatus of claim 1, wherein the one or more optimal turning paths are generated by a second trained machine-learning algorithm configured to reduce path lengths of the optimal turning paths.

7. The apparatus of claim 1, wherein the trajectory comprises an upcoming turning path, and velocity, time, and kinematics of the autonomous vehicle associated with the upcoming turning path.

8. The apparatus of claim 7, wherein the upcoming turning path is one of the one or more optimal turning paths.

9. The apparatus of claim 1, wherein the one or more processors are further operable to operate the autonomous vehicle to follow the trajectory by controlling or adjusting steering, throttle, braking inputs of the autonomous vehicle, or a combination thereof.

10. The apparatus of claim 1, wherein the one or more processors are further operable to:
monitor a track of the autonomous vehicle while passing the intersection;
determine whether the track strays from the trajectory; and
in responses to determining that the track strays from the trajectory, generate an updated trajectory for the autonomous vehicle to pass the intersection based on historical turning paths of the human-driven vehicles.

11. The apparatus of claim 1, wherein the map data comprises pedestrian crossings, traffic lights, traffic signs, barriers, road lanes, road edges, shoulders, dividers, paint markings, poles, or a combination thereof.

12. The apparatus of claim 1, wherein the map data is high-definition map data or standard-definition map data.

13. A method for trajectory planning comprising:
receiving an instruction to turn within an intersection;
planning a trajectory for an autonomous vehicle to turn within the intersection based on map data comprising one or more optimal turning paths associated with the intersection, wherein the one or more optimal turning paths are generated based on turning paths of one or more human-driven vehicles; and
instructing the autonomous vehicle to follow the trajectory to pass the intersection.

14. The method of claim 13, wherein:
the one or more optimal turning paths are generated further based on historical sensor data of the human-driven vehicles over time; and
the sensor data comprises speed data, acceleration data, steering data, yaw data, wheel slip data, lane departure data, time-of-day, weather conditions, vehicle type, vehicle size, minimum and maximum vehicle turning radii, or a combination thereof.

15. The method of claim 13, wherein:
the trajectory is generated, using a trained first machine-learning algorithm, based on the one or more optimal turning paths, and parameters of the autonomous vehicle against parameters of the human-driven vehicles associated with the one or more optimal turning paths; and
the parameters of the autonomous vehicle and the parameters of the human-driven vehicles comprise vehicle length, minimum turning radii, steering system, acceleration and deceleration performance, or a combination thereof.

16. The method of claim 13, wherein the one or more optimal turning paths are generated by a second trained machine-learning algorithm configured to reduce path lengths of the optimal turning paths.

17. The method of claim 13, wherein the trajectory comprises an upcoming turning path, and velocity, time, and kinematics of the autonomous vehicle associated with the upcoming turning path.

18. The method of claim 13, wherein the method further comprises operating the autonomous vehicle to follow the trajectory by controlling or adjusting steering, throttle, braking inputs of the autonomous vehicle, or a combination thereof.

19. The method of claim 13, wherein the method further comprises:
monitoring a track of the autonomous vehicle while passing the intersection;
determining whether the track strays from the trajectory; and
in responses to determining that the track strays from the trajectory, generating an updated trajectory for the autonomous vehicle to pass the intersection based on historical turning paths of the human-driven vehicles.

20. The method of claim 13, wherein the map data is high-definition map data or standard-definition map data.
